(19) United States
(12) Patent Application Publication
(10) Pub. No.: US 2017/0169239 A1
(43) Pub. Date: Jun. 15, 2017

(54) METHOD FOR FILE SYNCHRONIZATION, THE RECEIVER EQUIPMENT AND SYSTEMS

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Xiaofei ZHAO, Beijing (CN); Yong HU, Beijing (CN); Xiang CHEN, Beijing (CN); Wei XUE, Beijing (CN); Zetao WEI, Beijing (CN)

(73) Assignees: LE HOLDINGS (BEIJING) CO., LTD., Beijing (CN); LE SHI INTERNET INFORMATION & TECHNOLOGY CORP., BE IJING, Beijing (CN)

(21) Appl. No.: 15/242,196

(22) Filed: Aug. 19, 2016

Related U.S. Application Data
(63) Continuation of application No. PCT/CN2016/089557, filed on Jul. 10, 2016.

(30) Foreign Application Priority Data
Dec. 14, 2015 (CN) 201510925149.5

(51) Int. Cl. G06F 21/62; G06F 17/30; H04L 29/08

(52) U.S. Cl. CPC G06F 21/6218; H04L 67/06; G06F 17/30174

(57) ABSTRACT

A file synchronization method may include: receiving a file synchronization request from a sender device; sending a response message based on the request, wherein the response message includes a plurality of storage area addresses of a receiver device; receiving a plurality of file chunks that are sent by the sender device based on the response message, wherein the plurality of file chunks are obtained by chunking a to-be-transmitted file, and each of the plurality of file chunks includes a unique identifier and a storage area address, of the receiver device, corresponding to the unique identifier; and allocating each file chunk to a corresponding storage area according to the unique identifier of the file chunk and the storage area address, of the receiver device, corresponding to the unique identifier, and assembling, in real time, the plurality of file chunks that are stored in the storage areas, to obtain the to-be-transmitted file.

### CROSS-REFERENCE TO RELATED APPLICATIONS

This application is a continuation of PCT application No. PCT/CN2016/089557 submitted on Jul. 10, 2016, and this application is based upon and claims priority to Chinese Patent Application No. 201510925149.5, filed with the State Intellectual Property Office on Dec. 14, 2015, and entitled “FILE SYNCHRONIZATION METHOD, RECEIVER DEVICE, AND SYSTEM,” the entire contents of which are incorporated herein by reference.

### TECHNICAL FIELD

The present disclosure relates to the field of file synchronization, and more particularly, to a file synchronization method and an electronic device.

### BACKGROUND

In the current information age, file transmission has become indispensable. In conventional file transmission processes, an entire to-be-transmitted file is usually transmitted from a transmit end to a target receive end as an independent transmission part. However, when the to-be-transmitted file is large, the conventional file transmission methods have problems of low transmission efficiency and failure of file transmission due to unstable file transmission. In addition, as the file size continuously increases, the time of file transmission increases correspondingly, and the probability of successful transmission is affected, failing to ensure efficient and stable transmission of large files.

### SUMMARY

According to a first aspect, an embodiment of the present disclosure provides a file synchronization method, including: receiving a file synchronization request from a sender device; sending a response message to the sender device based on the request, wherein the response message includes a plurality of storage area addresses of a receiver device; receiving a plurality of file chunks that are sent by the sender device based on the response message, wherein the plurality of file chunks are obtained by chunking a to-be-transmitted file, and each of the plurality of file chunks includes a unique identifier and a storage area address, of the receiver device, corresponding to the unique identifier; and allocating each file chunk to a corresponding storage area according to the unique identifier of the file chunk and the storage area address, of the receiver device, corresponding to the unique identifier, and assembling, in real time, the plurality of file chunks that are stored in the storage areas, to obtain the to-be-transmitted file.

According to a second aspect, an embodiment of the present disclosure further provides a non-volatile computer storage medium, which stores computer executable instructions, wherein the computer executable instructions can be executed to perform any foregoing file synchronization method of the present disclosure.

According to a third aspect, an embodiment of the present disclosure further provides an electronic device, including: at least one processor; and a memory communicably connected with the at least one processor for storing instructions executable by the at least one processor, wherein execution of the instructions by the at least one processor causes the at least one processor to execute any foregoing file synchronization method of the present disclosure.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation. The accompanying drawings serve to provide further understanding to the present disclosure, constitute a part of the description, and explain the present disclosure with reference to the following specific implementation manners, but are not intended to limit the present disclosure. In the accompanying drawings:

FIG. 1 is a flowchart illustrating a file synchronization method according to Embodiment 1 of the present disclosure;

FIG. 2 is a flowchart illustrating a file synchronization method according to Embodiment 2 of the present disclosure;

FIG. 3 is a block diagram of a file synchronization system according to Embodiment 1 of the present disclosure; and

FIG. 4 is a schematic structural diagram of hardware of an electronic device for executing a file synchronization method according to Embodiment 5 of the present disclosure.

### DETAILED DESCRIPTION

Specific embodiments of the present disclosure are described hereinafter in detail with reference to the accompany drawings. It should be understood that the specific embodiments described hereinafter are merely for illustrating and explaining the present disclosure, not to limit the present disclosure.

### Embodiment 1

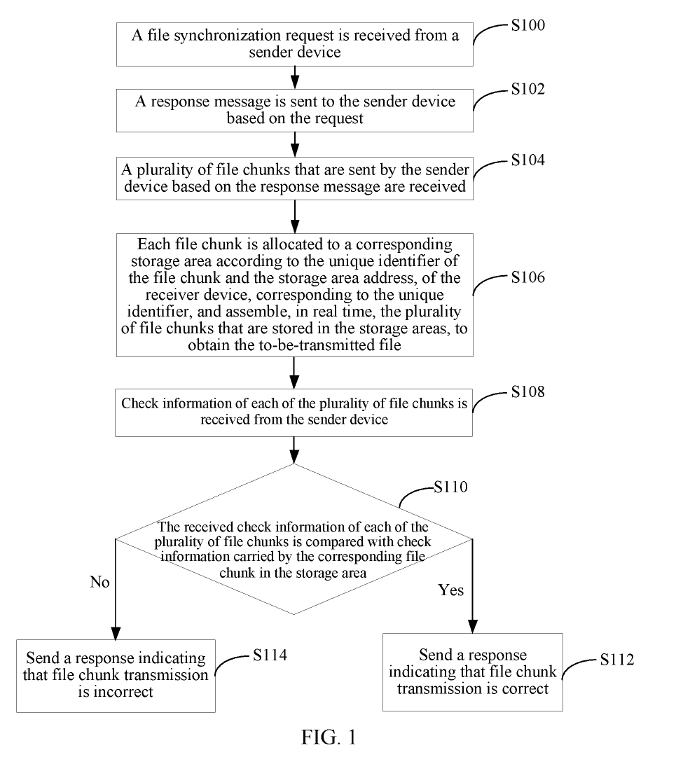

FIG. 1 is a flowchart illustrating a file synchronization method according to Embodiment 1 of the present disclosure.

As illustrated in FIG. 1, the file synchronization method according to one embodiment the present disclosure includes:

S100: A file synchronization request is received from a sender device.

S102: A response message is sent to the sender device based on the request, wherein the response message includes a plurality of storage area addresses of a receiver device.

S104: A plurality of file chunks that are sent by the sender device based on the response message are received, wherein the plurality of file chunks are obtained by chunking a to-be-transmitted file, and each of the plurality of file chunks includes a unique identifier and a storage area address, of the receiver device, corresponding to the unique identifier.

S106: Each file chunk is allocated to a corresponding storage area according to the unique identifier of the file chunk and the storage area address, of the receiver device, corresponding to the unique identifier, and assemble, in real time, the plurality of file chunks that are stored in the storage areas, to obtain the to-be-transmitted file.

A memory of the receiver device may obtain a plurality of storage areas through area division, and each area is used to store one file chunk.

A plurality of file chunks that are sent by a sender device and that are obtained by chunking a to-be-transmitted file are received, each file chunk is allocated to a corresponding storage area of a receiver device according to a unique identifier of the file chunk and a storage area address, of the receiver device, corresponding to the unique identifier, and the plurality of file chunks stored in the storage areas are assembled in real time, to obtain the to-be-transmitted file. In this way, a synchronization process of a to-be-transmitted file from a sender device to a receiver device may be implemented. In addition, because the to-be-transmitted file is chunked into a plurality of file chunks to transmit, the problem that a transmission error occurs because the file is large is avoided, thereby implementing stable and synchronous transmission of the file, and improving a transmission success rate.

In addition, in the method, the method may further include:

S108: Check information of each of the plurality of file chunks is received from the sender device.

S110: The received check information of each of the plurality of file chunks is compared with check information carried by the corresponding file chunk in the storage area.

S112: A response indicating that file chunk transmission is correct is sent when the received check information of each of the plurality of file chunks matches with the check information carried by the corresponding file chunk in the storage area.

S114: A response indicating that file chunk transmission is incorrect is sent when the received check information of each of the plurality of file chunks does not match with the check information carried by the corresponding file chunk in the storage area.

In this way, it may be judged whether the received file chunk is correct or not according to the check information, and the response is sent according to a judgment result, such that the sender device may know whether the sent file chunk is a correct file chunk.

In addition, the sender device may send a correct file chunk again to replace the incorrect file chunk, when the sent response is a response indicating that the file chunk is incorrect, to ensure correctness of the file synchronization.

In FIG. 1, although steps S108 to S114 illustrated are performed upon step S106, but the present disclosure is not limited thereto. For example, steps S108 to S114 may be perform before the plurality of file chunks stored in the storage areas are assembled in real time, such that a correct file chunk may be sent to replace the incorrect file chunk before the file chunks are assembled.

According to one embodiment of the present disclosure, the plurality of file chunks may be received in a parallel manner. In this way, a time taken by the file synchronization may be shortened, to improve efficiency.

According to one embodiment of the present disclosure, content that is sent and content that is received may be encrypted.

Security of the file transmission in a process of synchronous transmission may be ensured by encrypting the content that is sent and the content that is received.

For a specific encryption process, the skilled person in the art may implement by adopting conventional encryption manners in the prior art, and may decrypt by adopting corresponding decryption processes, which is not described in detail herein.

An embodiment of the present disclosure further provides a file synchronization receiver device, including: an apparatus, configured to receive a file synchronization request from a sender device; an apparatus, configured to send a response message to the sender device based on the request, wherein the response message includes a plurality of storage area addresses of the receiver device; an apparatus, configured to receive a plurality of file chunks that are sent by the sender device based on the response message, wherein the plurality of file chunks are obtained by chunking a to-be-transmitted file, and each of the plurality of file chunks includes a unique identifier and a storage area address, of the receiver device, corresponding to the unique identifier; and an apparatus, configured to: allocate each file chunk to a corresponding storage area according to the unique identifier of the file chunk and the storage area address, of the receiver device, corresponding to the unique identifier, and assemble, in real time, the plurality of file chunks that are stored in the storage areas, to obtain the to-be-transmitted file.

A plurality of file chunks that are sent by a sender device and that are obtained by chunking a to-be-transmitted file are received, each file chunk is allocated to a corresponding storage area of the receiver device according to a unique identifier of the file chunk and a storage area address, of the receiver device, corresponding to the unique identifier, and the plurality of file chunks stored in the storage areas are assembled in real time, to obtain the to-be-transmitted file. In this way, a synchronization process of a to-be-transmitted file from a sender device to the receiver device may be implemented. In addition, because the to-be-transmitted file is chunked into a plurality of file chunks to transmit, the problem that a transmission error occurs because the file is large is avoided, thereby implementing stable and synchronous transmission of the file, and improving a transmission success rate.

According to one embodiment of the present disclosure, the receiver device may further include: an apparatus, configured to receive check information of each of the plurality of file chunks from the sender device; an apparatus, configured to compare the received check information of each of the plurality of file chunks with check information carried by the corresponding file chunk in the storage area; an apparatus, configured to send a response indicating that a file chunk transmission is correct when the received check information of each of the plurality of file chunks matches with the check information carried by the corresponding file chunk in the storage area; and an apparatus, configured to send a response indicating that a file chunk transmission is incorrect when the received check information of each of the plurality of file chunks does not match with the check information carried by the corresponding file chunk in the storage area.

In this way, it may be judged whether the received file chunk is correct or not according to the check information, and the response is sent according to a judgment result, such that the sender device may know whether the sent file chunk is a correct file chunk, and may send a correct file chunk again to replace the incorrect file chunk, when the sent response is a response indicating that the file chunk is incorrect, to ensure correctness of file synchronization.

According to one embodiment of the present disclosure, content that is sent and content that is received may be encrypted.

Security of the file transmission in a process of synchronous transmission may be ensured by encrypting the content that is sent and the content that is received.

### Embodiment 2

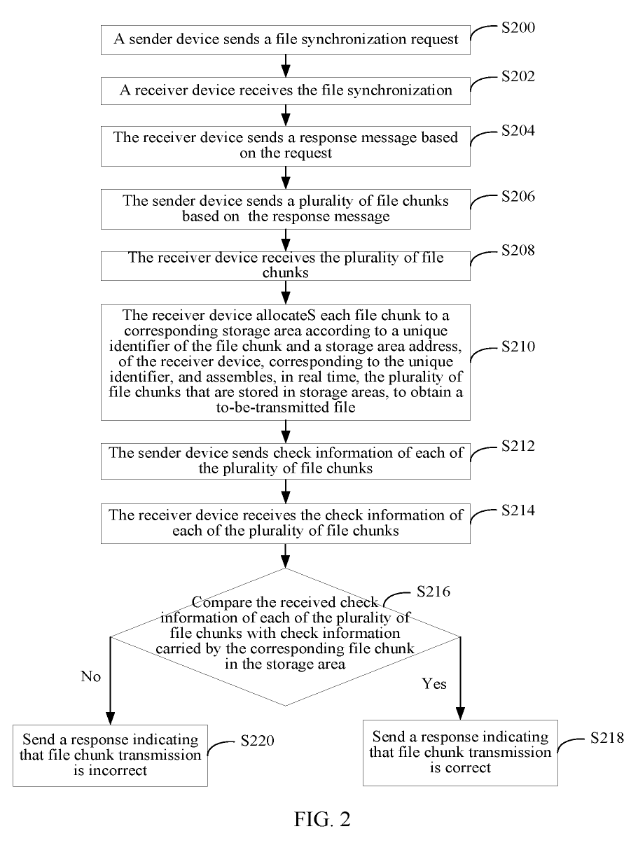

FIG. 2 is a flowchart illustrating a file synchronization method according to another embodiment of the present disclosure.

As illustrated in FIG. 2, the file synchronization method according to another embodiment of the present disclosure includes:

S200: A sender device sends a file synchronization request.

S202: A receiver device receives the file synchronization.

S204: The receiver device sends a response message based on the request, wherein the response message includes a plurality of storage area addresses of the receiver device.

S206: The sender device sends a plurality of file chunks based on the response message, wherein the plurality of file chunks are obtained by chunking a to-be-transmitted file, and each of the plurality of file chunks includes a unique identifier and a storage area address, of the receiver device, corresponding to the unique identifier.

S208: The receiver device receives the plurality of file chunks.

S210: The receiver device allocates each file chunk to a corresponding storage area according to the unique identifier of the file chunk and the storage area address, of the receiver device, corresponding to the unique identifier, and assembles, in real time, the plurality of file chunks that are stored in the storage areas, to obtain the to-be-transmitted file.

A plurality of file chunks that are sent by a sender device and that are obtained by chunking a to-be-transmitted file are received, each file chunk is allocated to a corresponding storage area of a receiver device according to a unique identifier of the file chunk and a storage area address, of the receiver device, corresponding to the unique identifier, and the plurality of file chunks stored in the storage areas are assembled in real time, to obtain the to-be-transmitted file. In this way, a synchronization process of a to-be-transmitted file from a sender device to a receiver device may be implemented. In addition, because the to-be-transmitted file is chunked into a plurality of file chunks to transmit, the problem that a transmission error occurs because the file is large is avoided, thereby implementing stable and synchronous transmission of the file, and improving a transmission success rate.

The method may further include the following steps:

S212: The sender device sends check information of each of the plurality of file chunks.

S214: The receiver device receives the check information of each of the plurality of file chunks.

S216: The receiver device compares the received check information of each of the plurality of file chunks with check information carried by the corresponding file chunk in the storage area.

S218: The receiver device sends a response indicating that a file chunk transmission is correct when the received check information of each of the plurality of file chunks matches with the check information carried by the corresponding file chunk in the storage area.

S220: The receiver device sends a response indicating that a file chunk transmission is incorrect when the received check information of each of the plurality of file chunks does not match with the check information carried by the corresponding file chunk in the storage area.

In this way, the receiver device may judge whether the received file chunk is correct or not according to the check information, and send the response to the sender device according to a judgment result, such that the sender device may know whether the sent file chunk is a correct file chunk.

In addition, the sender device may send a correct file chunk to the receiver device again to replace the incorrect file chunk, when the sent response is a response indicating that the file chunk is incorrect, to ensure correctness of the file synchronization.

In FIG. 2, although steps S212 to S220 illustrated are performed after step S210, but the present disclosure is not limited thereto. For example, steps S212 to S220 may be performed before the plurality of file chunks stored in the storage areas are assembled in real time, such that a correct file chunk may be sent to replace the incorrect file chunk before the file chunks are assembled.

According to one embodiment of the present disclosure, the receiver device receives the plurality of file chunks in a parallel manner. In this way, a time taken by the file synchronization may be shortened, to improve efficiency.

According to one embodiment of the present disclosure, content that is sent and content that is received may be encrypted.

Security of the file transmission in a process of synchronous transmission may be ensured by encrypting the content that is sent and the content that is received.

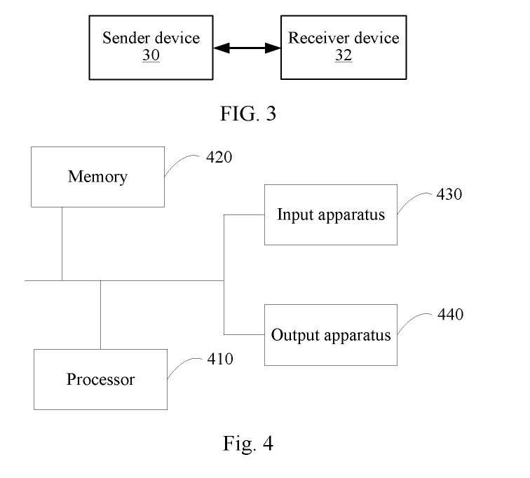

FIG. 3 is a block diagram illustrating a file synchronization system according to one embodiment of the present disclosure.

As illustrated in FIG. 3, the file synchronization system according to an embodiment the present disclosure includes a sender device 30 and a receiver device 32.

The sender device 30 is configured to send a file synchronization request.

The receiver device 32 is configured to receive the file synchronization.

The receiver device 32 is further configured to send a response message to the sender device based on the request, wherein the response message includes a plurality of storage area addresses of the receiver device.

The sender device 30 is further configured to send a plurality of file chunks based on the response message, wherein the plurality of file chunks are obtained by chunking a to-be-transmitted file, and each of the plurality of file chunks includes a unique identifier and a storage area address, of the receiver device, corresponding to the unique identifier.

The receiver device 32 is further configured to receive the plurality of file chunks.

The receiver device 32 is further configured to: allocate each file chunk to a corresponding storage area according to the unique identifier of the file chunk and the storage area address, of the receiver device, corresponding to the unique identifier, and assemble, in real time, the plurality of file chunks that are stored in the storage areas, to obtain the to-be-transmitted file.

A plurality of file chunks that are sent by the sender device and that are obtained by chunking a to-be-transmitted file are received, each file chunk is allocated to a corresponding storage area of the receiver device according to a unique identifier of the file chunk and a storage area address, of the receiver device, corresponding to the unique identifier, and the plurality of file chunks stored in the storage areas are assembled in real time, to obtain the to-be-transmitted file. In this way, a synchronization process of a to-be-transmitted file from the sender device to the receiver device may be implemented. In addition, because the to-be-transmitted file is chunked into a plurality of file chunks to transmit, the problem that a transmission error occurs because the file is large is avoided, thereby implementing stable and synchronous transmission of the file, and improving a transmission success rate.

According to one embodiment of the present disclosure, in the system:

the sender device 30 is further configured to send check information of each of the plurality of file chunks;

the receiver device 32 is further configured to receive the check information of each of the plurality of file chunks;

the receiver device 32 is further configured to compare the received check information of each of the plurality of file chunks with check information carried by the corresponding file chunk in the storage area;

the receiver device 32 is further configured to send a response indicating that a file chunk transmission is correct when the received check information of each of the plurality of file chunks matches with the check information carried by the corresponding file chunk in the storage area; and the receiver device 32 is further configured to send a response indicating that a file chunk transmission is incorrect when the received check information of each of the plurality of file chunks does not match with the check information carried by the corresponding file chunk in the storage area.

In this way, the receiver device 32 may judge whether the received file chunk is correct or not according to the check information, and send the response to the sender device 30 according to a judgment result, such that the sender device 30 may know whether the sent file chunk is a correct file chunk.

In addition, the sender device 30 may send a correct file chunk to the receiver device 32 again to replace the incorrect file chunk, when the sent response is a response indicating that the file chunk is incorrect, to ensure correctness of the file synchronization.

In the present disclosure, both of the sender device 30 and the receiver device 32 may be a customer end or a server, or one may be a customer end and the other is a server. Specifically, the skilled person in the art may set according to an actual case, which is not limited thereto.

According to one embodiment of the present disclosure, content that is sent and content that is received may be encrypted.

Security of the file transmission in a process of synchronous transmission may be ensured by encrypting the content that is sent and the content that is received.

### Embodiment 4

Embodiment 4 of the present disclosure further provides a non-volatile computer storage medium, which stores computer executable instructions, wherein the computer executable instructions can be executed to perform any one of the mentioned methods for file synchronization prescribed by the present disclosure.

### Embodiment 5

FIG. 4 is a schematic structural diagram of hardware of an electronic device for executing a file synchronization method according to Embodiment 5 of the present disclosure. As shown in FIG. 4, the device includes: one or more processors 410 and a memory 420, wherein only one processor 410 is used as an example in FIG. 4.

The device for executing the file synchronization method may further include: an input apparatus 430 and an output apparatus 440.

The processor 410, the memory 420, the input apparatus 430, and the output apparatus 440 can be connected by means of a bus or in other manners. A connection by means of a bus is used as an example in FIG. 4.

As a non-volatile computer readable storage medium, the memory 420 can be used to store non-volatile software programs, non-volatile computer executable programs and modules, for example, a program instruction/module corresponding to the file synchronization method in the embodiments of the present disclosure. The processor 410 executes various functional disclosures and data processing of the server, that is, implements the file synchronization method of the foregoing method embodiments, by running the non-volatile software programs, instructions, and modules stored in the memory 420.

The memory 420 may include a program storage area and a data storage area, wherein the program storage area may store an operating system and at least one disclosure needed by function; the data storage area may store data created according to use of the server, and the like. In addition, the memory 420 may include a high-speed random access memory, and also may include a non-volatile memory such as at least one disk storage device, flash storage device, or other non-volatile solid-state storage devices. In some embodiments, the memory 420 optionally includes memories remotely disposed with respect to the processor 410, and the remote memories may be connected, via a network, to the server. Examples of the foregoing network include but are not limited to: the Internet, an intranet, a local area network, a mobile communications network, and a combination thereof.

The input apparatus 430 can receive entered digits or character information, and generate key signal inputs relevant to user setting and functional control of the server. The output apparatus 440 may include a display device, for example, a display screen, etc.

The one or more modules are stored in the memory 420, and execute the file synchronization method in any of the foregoing method embodiments when being executed by the one or more processors 410.

The foregoing product can execute the method provided in the embodiments of this disclosure, and has corresponding functional modules for executing the method and beneficial effects. The method provided in the embodiments of this disclosure can be referred to for technical details that are not described in detail in this embodiment.

The electronic device in the embodiments of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

What is claimed is:

1. A file synchronization method, comprising:
receiving a file synchronization request from a sender device;
sending a response message to the sender device based on the request, wherein the response message comprises a plurality of storage area addresses of a receiver device;
receiving a plurality of file chunks that are sent by the sender device based on the response message, wherein the plurality of file chunks are obtained by chunking a to-be-transmitted file, and each of the plurality of file chunks comprises a unique identifier and a storage area address, of the receiver device, corresponding to the unique identifier; and
allocating each file chunk to a corresponding storage area according to the unique identifier of the file chunk and the storage area address, of the receiver device, corresponding to the unique identifier, and assembling, in real time, the plurality of file chunks that are stored in the storage areas, to obtain the to-be-transmitted file.

2. The method according to claim 1, further comprising:
receiving check information of each of the plurality of file chunks from the sender device;
comparing the received check information of each of the plurality of file chunks with check information carried by the corresponding file chunk in the storage area;
sending a response indicating that a file chunk transmission is correct when the received check information of each of the plurality of file chunks matches with the check information carried by the corresponding file chunk in the storage area, and
sending a response indicating that a file chunk transmission is incorrect when the received check information of each of the plurality of file chunks does not match with the check information carried by the corresponding file chunk in the storage area.

3. The method according to claim 1, wherein the plurality of file chunks are received in a parallel manner.

4. The method according to claim 1, wherein content that is sent and content that is received are encrypted.

5. A non-transitory computer-readable storage medium which stores computer executable instructions that, when executed by an electronic device, causes the electronic device to:
receive a file synchronization request from a sender device;
send a response message to the sender device on the basis of the request, wherein the response message comprises multiple storage area addresses of a receiver device;
receive multiple file chunks that are sent by the sender device based on the response message, wherein the multiple file chunks are obtained by chunking a to-be-transmitted file, and each of the multiple file chunks comprises a unique identifier and a storage area address that is of the receiver device and corresponding to the unique identifier; and
allocate each file chunk to a corresponding storage area according to the unique identifier of the file chunk and the storage area address that is of the receiver device and corresponding to the unique identifier, and assemble, in real time, the multiple file chunks that are stored in the storage areas, so as to obtain the to-be-transmitted file.

6. The non-transitory computer-readable storage medium according to claim 5, wherein the computer executable instructions further cause the electronic device to:
receive check information of each of the multiple file chunks from the sender device;
respectively compare the received check information of each of the multiple file chunks with check information carried by the corresponding file chunk in the storage area;
send a response indicating that a file chunk transmission is correct, in a case in which a comparison result is matching, and
send a response indicating that a file chunk transmission is incorrect, in a case in which a comparison result is not matching.

7. The non-transitory computer-readable storage medium according to claim 5, wherein the multiple file chunks are received in a parallel manner.

8. The non-transitory computer-readable storage medium according to claim 5, wherein content that is sent and content that is received are encrypted.

9. An electronic device, comprising:
at least one processor; and
a memory communicably connected with the at least one processor for storing instructions executable by the at least one processor,
wherein execution of the instructions by the at least one processor causes the at least one processor to:
receive a file synchronization request from a sender device;
send a response message to the sender device on the basis of the request, wherein the response message comprises multiple storage area addresses of a receiver device;
receive multiple file chunks that are sent by the sender device based on the response message, wherein the multiple file chunks are obtained by chunking a to-be-transmitted file, and each of the multiple file chunks comprises a unique identifier and a storage area address that is of the receiver device and corresponding to the unique identifier; and
allocate each file chunk to a corresponding storage area according to the unique identifier of the file chunk and the storage area address that is of the receiver device and corresponding to the unique identifier, and assemble, in real time, the multiple file chunks that are stored in the storage areas, so as to obtain the to-be-transmitted file.

10. The electronic device according to claim 9, wherein the at least one processor is further caused to:
receive check information of each of the multiple file chunks from the sender device;
respectively compare the received check information of each of the multiple file chunks with check information carried by the corresponding file chunk in the storage area;
send a response indicating that a file chunk transmission is correct, in a case in which a comparison result is matching, and
send a response indicating that a file chunk transmission is incorrect, in a case in which a comparison result is not matching.

11. The electronic device according to claim 9, wherein the multiple file chunks are received in a parallel manner.

12. The electronic device according to claim 9, wherein content that is sent and content that is received are encrypted.
